(19) United States
(12) Patent Application Publication
(10) Pub. No.: US 2006/0119906 A1
(43) Pub. Date: Jun. 8, 2006

(54) Apparatus to measure vertical distance between flat bed and document, and scanner and scanning method capable of compensating distortion

(76) Inventor: Jie-hwan Park, Hwaseong-si (KR)

Correspondence Address: STANZIONE & KIM, LLP, 919 18TH STREET, N.W., SUITE 440, WASHINGTON, DC, 20006, US

(21) Appl. No.: 11/290,553

(22) Filed: Dec. 1, 2005

(30) Foreign Application Priority Data
Dec. 3, 2004 (KR) 2004-101153

(51) Int. Cl. H04N 1/04

(52) U.S. Cl. 358/488

(57) ABSTRACT

An apparatus to measure a vertical distance between a document and a flat bed, and a scanner and a scanning method of compensating for distorted image information using the measured vertical distance. The apparatus to measure the vertical distance includes a light emitter to scan light at a predetermined emission angle along a predetermined reference line on the flat bed of a scanner, a light detector to detect the emitted light, a horizontal distance detector to measure a horizontal distance of the detected light from the predetermined reference line, and a vertical distance calculation unit to calculate the vertical distance between the flat bed and the document placed on the flat bed using the measured horizontal distance and the predetermined emission angle. Accordingly, it is possible to compensate for the distorted image information using the vertical distance between the flat bed and the document.

### CROSS-REFERENCE TO RELATED APPLICATIONS

This application claims the benefit of Korean Patent Application No. 10-2004-101153, filed on Dec. 3, 2004, in the Korean Intellectual Property Office, the disclosure of which is incorporated herein in its entirety by reference.

### BACKGROUND OF THE INVENTION

1. Field of the Invention

The present general inventive concept relates to a scanner, and more particularly, to a scanner and a scanning method capable of compensating for distorted image information by measuring a vertical distance between a flat bed and a document.

2. Description of the Related Art

A scanner is a device for converting image information in a document, a drawing, a picture, etc., to digital data and then storing the converted digital data as a graphic file in a computer using software.

The scanner has reading mechanism for reading the information from the document. There are two-dimensional information reading type reading mechanisms and one-dimensional information reading type reading mechanisms. Generally, the scanner for reading the document or performing a product test employs the one-dimensional information reading type reading mechanism. The one-dimensional information represents information read in a line-type, and the two-dimensional information represents information read in a sheet-type. It is necessary to move either the reading mechanism or the document in order to read the sheet-type information with the line-type reading mechanism. The line-type information read while moving the reading mechanism or the document is accumulated in a time series, thus composing the sheet-type information. A scanner in which the reading mechanism is moved is called as a flat-bed scanner. A scanner in which the document is moved is called a sheet feed type scanner and employs a different operation method from the flat-bed scanner.

The sheet feed type scanner is a scanner in which the reading mechanism is fixed and the document is moved. However, such a classification is arbitrary because there is also a flat-bed scanner in which the reading mechanism is fixed and the document is moved. Therefore, hereinafter, a scanner in which the reading mechanism is moved regardless of the movement of the document is defined as the flat-bed scanner in order to distinguish it from the sheet feed type scanner.

A process of obtaining a scanned image using the scanner is generally divided into the following two stages. A first stage is a preview process of viewing a whole image and a second stage is a final scan process of actually scanning the image by setting an actual scanning area and additional information such as resolution.

The preview process normally includes a process of scanning with a low resolution all areas where the scanner scans. The reason for scanning with the low resolution is to improve the preview speed. However, all areas of a flat bed should be scanned even in a case of previewing printed matter smaller in size than the flat bed where the document is placed for scanning. A user can designate an area to finally scan or set an alignment state of an object to be scanned, a desired resolution, etc., through the preview process.

FIG. 1A is a diagram illustrating a state in which a document is placed on a flat bed in a conventional flat-bed scanner.

As illustrated in FIG. 1A, a point of the document is separated from the flat bed according to a state of the document placed on the flat bed. Specifically, when the document is a book, a center portion of the book is greatly separated from the flat bed. For example, when two adjacent pages of the book disposed opposite to each other with respect to the center portion are placed to face the flat bed to be scanned, first portions of the two pages are in contact with the flat bed, and second portions of the two pages are not in contact with the flat bed. The second portions may not be parallel to the flat bed and may be spaced-apart from the flat bed. The second portions may be disposed adjacent to the center portion of the book.

FIG. 1B is a diagram illustrating distorted image information corresponding to the document in the conventional flat-bed scanner of FIG. 1.

The more separated from the flat bed the document is, the more distorted the image information read at the point of separation is. As illustrated in FIG. 1B, the scanning is performed such that all characters at edges of the document in close contact with the flat bed are readable but serious distortion takes place at central portions of the document. The damage to important information arising from the serious distortion of the image scanned from the document causes inconvenience to a user.

Further, an additional amount of labor may be needed, thus delaying the scanning work, and breakage of the flat bed may occur if the book is pressed to be in close contact with the flat bed in order to prevent the distortion of the images scanned from the book.

Therefore, a technique capable of compensating for the distorted image information when a document is separated from the flat bed is desirable.

### SUMMARY OF THE INVENTION

The present general inventive concept provides an apparatus capable of easily measuring a vertical distance between a flat bed and a document.

The present general inventive concept also provides a scanner capable of measuring a vertical distance between a flat bed and a document and compensating for distorted image information using the measured vertical distance.

The present general inventive concept also provides a scanning method of compensating for distorted image information using a vertical distance between the flat bed and the document.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing an apparatus to measure a vertical distance between a document and a flat bed, the apparatus comprising a light emitter to emit light at a predetermined emission angle along a predetermined reference line on the flat bed of a scanner, a light detector to detect the emitted light, a horizontal distance detector to measure the horizontal distance at which the detected light is separated from the reference line, and a vertical distance calculation unit to calculate a vertical distance at which a document placed on the flat bed is separated from the flat bed according to the horizontal distance and the emission angle.

The foregoing and/or other aspects of the present general inventive concept may also be achieved by providing a scanner having a function of compensating for distortion of image information read from a document placed on a flat bed, the scanner comprising a calculation unit to measure a vertical distance between the document and the flat bed, the calculating unit comprising a light emitter to emit light at a predetermined emission angle along a predetermined reference line on the flat bed, a light detector to detect the emitted light, a horizontal distance detector to measure the horizontal distance at which the detected light is separated from the reference line, and a vertical distance calculation unit to calculate the vertical distance at which the document placed on the flat bed are separated from the flat bed using the horizontal distance and the emission angle, a distortion compensation unit to compensate for the read image information according to the detected vertical distance, and a central controller to control operations of components of the scanner.

The light emitter may sequentially scan the light along the reference line and the light detector may detect the light in synchronization with the light emitter.

The light emitter may comprise one light lamp to emit a predetermined wavelength of light.

The vertical distance calculation unit may generate a vertical distance graph showing the vertical distance with respect to the reference line.

The foregoing and/or other aspects of the present general inventive concept may also be achieved by providing a scanning method having a function of compensating for distortion of image information read from a document placed on a flat bed, the scanning method comprising emitting light at a predetermined emission angle along a predetermined reference line on the flat bed, detecting the emitted light, detecting a vertical distance which calculates the horizontal distance at which the detected light is separated from the reference line and the vertical distance at which documents placed on the flat bed is separated from the flat bed according to the emission angle, scanning images of the document to read the image information about the document, and compensating for distortion to compensate the read information according to the detected vertical distance.

The emitting of the light may comprise sequentially emitting the light along the reference line. The detecting of the light may comprise detecting the light in synchronization with the emitting of the light.

The calculating of the horizontal distance may comprise generating a vertical distance graph showing the vertical distance relative to the reference line.

The reference line may be positioned at a center portion of the flat bed.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1A is a diagram illustrating a state in which a document is placed on a flat bed in a conventional flat-bed scanner;

FIG. 1B is a diagram illustrating distorted image information corresponding to a document in the conventional flat-bed scanner of FIG. 1A;

FIG. 2 is a perspective view illustrating a scanner including an apparatus to measure a vertical distance between a document and a flat bed according to an embodiment of the present general inventive concept;

FIG. 3 is a cross-sectional view illustrating the apparatus to measure the vertical distance of FIG. 2 and a diagram illustrating a measured horizontal distance;

FIG. 4 is a block diagram illustrating an apparatus to measure a vertical distance according to an embodiment of the present general inventive concept;

FIG. 5A is a diagram illustrating an exemplary vertical distance graph generated by the apparatus of FIG. 4 to measure the vertical distance;

FIG. 5B is a diagram illustrating a process of calculating a distortion ratio at a portion of the vertical distance graph in the apparatus of FIG. 4;

FIG. 6 is a flowchart illustrating a scanning method according to an embodiment of the present general inventive concept; and

FIG. 7 is a block diagram illustrating a scanner according to another embodiment of the present general inventive concept.

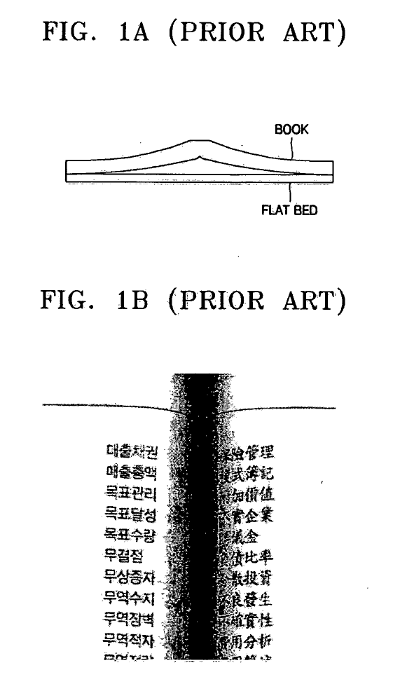

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

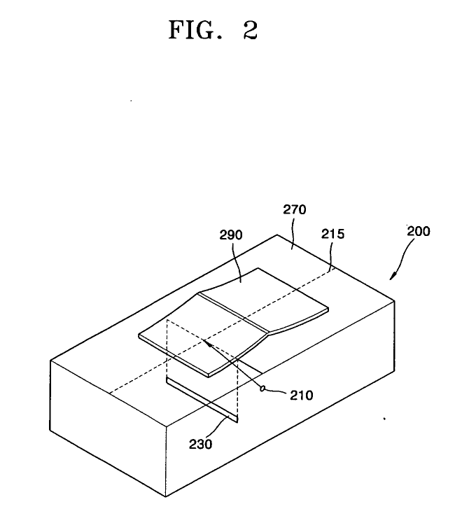

FIG. 2 is a perspective view illustrating a scanner 200 including an apparatus to measure a vertical distance between a document and a flat bed according to an embodiment of the present invention.

Referring to FIG. 2, the scanner 200 includes a flat bed 270, a light scanning unit or a light emitter 210, and a horizontal distance detector 230.

Operations of the scanner 200 are described as follows. The light emitter 210 applies (emits) light of a predetermined wavelength to a reference line 215 when a document 290, such as a book, is placed on the flat bed 270. The wavelength of the light to be scanned can be one of all wavelengths that the horizontal distance detector 230 can sense. The light emitter 210 may emit a light beam as the light. The light emitter 210 changes a direction of the light to scan the light along the reference line 215. For example, as illustrated in FIG. 2, the emitted light is scanned from a left side to a right side or the right side to the left side along the reference line 215. Further, the horizontal distance detector 230 moves in synchronization with the light emitted from the light emitter 210 and detects the scanned light. The light emitter 210 is disposed at a position which is on a plane not perpendicular to the reference line 215 and/or the flat bed 270, so that the light emitted from the light emitter 210 is incident to the reference line 215 at an angle which is not a right angle of the flat bed 270. It is possible that the light emitter 210 is disposed at a position perpendicular to the reference line 215, and the horizontal distance detector 230 is disposed along a direction perpendicular to the reference line and moves along a direction parallel to the reference line 215.

The light emitter 210 applies (emits) the light accurately toward the reference line 215 to scan the document with respect to the reference line 215. Therefore, the document 290 to be scanned is detected as a scanned line which is in line with the reference line when it is in close contact with the flat bed 270. That is, when two adjacent pages of the book disposed opposite to each other with respect to a central portion of the book are placed to face the flat bed 270 to be scanned, first portions of the two pages are in contact with the flat bed 270, and second portions of the two pages are not in contact with the flat bed 270. The second portions may not be parallel to the flat bed 270 but spaced-apart from the flat bed. The second portions may be disposed adjacent to the center portion of the book. The light corresponding to the first portions of the book may be in line with the reference line. However, the light scanned from the light emitter 210 may pass the reference line 215 and may form the scanned line on the second portions to be detected by the horizontal distance detector 230 since the second portions of the document 290 to be scanned are separated from the flat bed 270. The horizontal distance detector 230 then detects a horizontal distance between the scanned line and the reference line The scanned line may comprise a plurality of dots which are separated from each other.

The detected horizontal distance is converted to a vertical distance by a vertical distance calculation unit (not shown). The vertical distance is a distance representing a separation between the document 290 and the flat bed 270.

The vertical distance causes distortion to be generated when scanning the document 290. The vertical distance calculated by the vertical distance calculation unit is stored as a vertical distance graph to show a relationship between the scanned line and the reference line 215 because the light emitter 210 applies the light along the reference line 215, the scanned light is detected as the scanned line by the horizontal distance detector 230. The vertical distance calculation unit may be an arithmetic logic unit (ALU) which receives the horizontal distance from the horizontal distance detector 230. Alternatively, a central controller (not shown) of the scanner 200 may operate as the vertical distance calculation unit.

Although the horizontal distance detector 230 may be embodied as a separate device from the light emitter 210 and a light detector to read image information of the document 290, the horizontal distance detector 230 may operate as the light detector to read the image information of the document 290, for example, the image information of the pages of the book, on the flat bed 270 of the scanner 200. In this case, the horizontal distance detector 230 can detect the horizontal distance of the scanned line formed by the light scanned from the light emitter 210 during an operation such as a preview scan operation. That is, during the preview scan operation, the horizontal distance detector 230 can measure the horizontal distance between the scanned line and the reference line 215, and during a final scanning operation, the horizontal distance detector 230 can read the image information of the document 290 using the light of a light source. The horizontal distance detector 230 can detect the horizontal distance separately from the image information during the preview scan operation to avoid mixing the light emitted from the light emitter 210 with the image information of the document 290 during the final scanning operation.

A process of converting the horizontal distance detected by the horizontal distance detector 230 to the vertical distance will be described later.

When the vertical distance graph is prepared, the scanner 200 performs the final scanning operation and reads the image information about the document 290. As described above, the horizontal distance detector 230 of the scanner 200 can perform the final scanning operation to read to the image information of the document 290.

The scanner 200 operates as follows in order to perform the final scanning operation.

The document 290 to be scanned is placed on the flat bed 270 and is covered with a scanner cover (not shown). A scan motor (not shown) is driven, and a drive force of the scan motor drives an optical scan device through a gear train. As illustrated in FIG. 2, the optical scan device may include the horizontal distance detector 230 to read the scanned line, and/or the light detector to read the image information. Accordingly, reference numeral 230 of FIG. 2 refers to the optical scan device and the horizontal distance detector. The optical scan device 230 then scans the document 290 while moving along a guide shaft (not shown). As illustrated in FIG. 2, the optical scan device 230 scans the document 290 along the reference line 215. A belt tension device (not shown) can be provided to prevent a belt to move the optical scan device 230 along the guide shaft from loosening. The image information is generated and is output when the optical scan device 230 completes the scanning of the document 290. The output image information can be displayed on a computer monitor, edited or corrected using an edit program, and stored into a desired image file format. When the image information is read by the optical scan device 230, distortions of the image information due to separation between the document 290 and the flat bed 270 are compensated using the vertical distance graph. A method of compensating for the distorted image information will be described in greater detail below.

The optical scan device 230 can include a device such as charge coupled device (CCD) or a contact image sensor (CIS) to read the image information of the document 290 to be scanned. As described above, the optical scan device 230 may operate as the horizontal distance detector 230 to measure the horizontal distance from the reference line 215 at which the light emitted from the light emitter 210 is detected. Although the optical scan device 230 is illustrated in FIG. 2 as being the horizontal distance detector 230, the present general inventive concept is not limited thereto, and the horizontal distance detector 230 and the optical scan device may be separately provided in the scanner 200.

As illustrated in FIG. 2, the scanner 200 measures a distance between the flat bed 270 and the document 290 and compensates for distortion in the obtained image information using the measured distance, thus minimizing loss of important information.

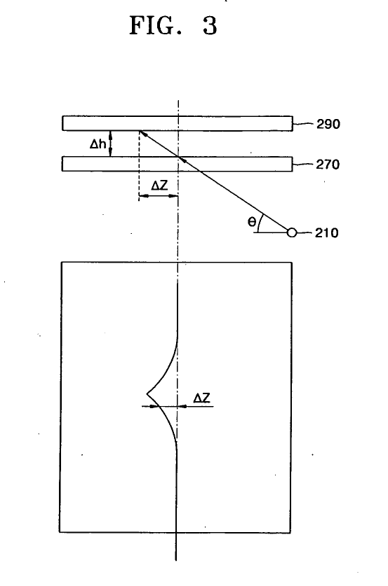

FIG. 3 is a cross-sectional view of the apparatus to measure the vertical distance of FIG. 2 and a diagram illustrating the measured horizontal distance.

For a better understanding, FIG. 3 illustrates that the document 290 to be scanned is separated by a fixed distance Δh from the flat bed 270.

The light emitter unit 210 applies (emits) the predetermined wavelength of light toward the reference line 215. The scanned line formed on the document 290 by the emitted light is detected at a horizontal distance Δz from the reference line 215 because the document 290 to be scanned is separated by a vertical distance Ah from the flat bed 270. The horizontal distance detector 230 (FIG. 2) measures the horizontal distance Δz at which the light is detected with respect to the reference line 215.

The horizontal distance Δz is detected as shown on a horizontal distance graph of FIG. 3 as the light emitter 210 continuously applies the light along the reference line 215 and the horizontal distance Δz of the emitted light is synchronized and detected. As illustrated in the horizontal distance graph, if the document 290 to be scanned is a book, the horizontal distance Δz becomes 0 at both ends of a book, but reaches a maximum at a middle portion of the book, i.e., the center portion of the book. That is, the horizontal distance Δz is 0 in the first portions of the pages of the book which is parallel to the flat bed 270, and varies in the second portions of the pages of the book.

Referring to FIG. 3, when the light is emitted from the light emitter 210 at an angle θ with respect to the horizontal direction, a relationship between the horizontal distance Δz and the vertical distance Δh is given by Equation 1.
Δh=Δz*tan(θ) Equation 1

As illustrated in FIG. 3, the light emitter 210 continuously applies the light to scan the document with respect to the reference line 215, and the scanned light is continuously detected. The measured horizontal distance graph is continuous because the light emitter 210 continuously applies the light. However, it is not necessary to continuously scan the light for the light emitter 210, and it is possible to sequentially scan the light at predetermined time intervals. In this case, the measured horizontal distance graph is discrete. Accordingly, the embodiment of FIG. 3 does not limit the present general inventive concept.

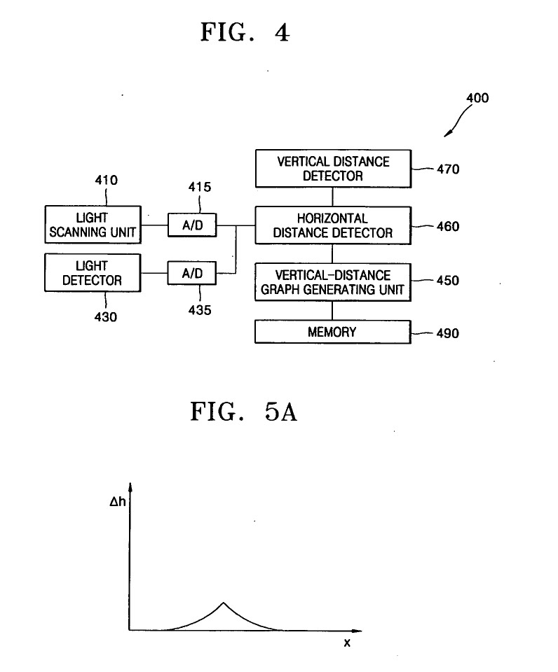

FIG. 4 is a block diagram illustrating an apparatus 400 to measure a vertical distance between a document and a flat bed of a scanner according to an embodiment of the present general inventive concept.

Referring to FIG. 4, the apparatus 400 to measure the vertical distance includes a light scanning unit or a light emitter 410, a light detector 430, first and second analog/digital converters (A/D) 415 and 435, a vertical distance detector 470, a horizontal distance detector 460, a vertical-distance graph generating unit 450, and a memory 490.

The light emitted from the light emitter 410 which may correspond to the light scanning unit (light emitter) 210 of FIG. 2 to scan a document with respect to a reference line is converted into a digital signal by the first analog/digital converter 415. The scanned light is converted to the digital signal to be transmitted to other components of the apparatus 400. Signals output from the light detector 430 are converted to digital signals by the second analog/digital converter 435.

The light emitted from the light emitter 410 to scan the document can be detected by the horizontal distance detector 460 or the light detector 430. As illustrated in FIG. 4, the apparatus 400 to measure the vertical distance can separately include the light detector 430 and the horizontal distance detector 460. Accordingly, the light scanned from the light emitter 410 is detected by the horizontal distance detector 460, and the light detector 430 can be used to read image information of the document to be scanned, if the horizontal distance detector 460 and the light detector 430 are individually provided. However, as described above in the previous embodiment, the two devices may be combined into a single component, i.e., the optical scanner device.

Further, the light emitter 410 can emit light toward the flat bed of the scanner with one light scanning lamp. Accordingly, it is possible to measure a horizontal distance with only one light lamp, whereby a production cost can be reduced. It is simple and convenient to measure the horizontal distance with only one light lamp, rather than with two or more lamps.

The horizontal distance detected from the horizontal distance detector 460 is converted to a vertical distance by the vertical distance detector 470. Referring to FIG. 3, the vertical distance can be calculated using a trigonometry on the basis of the horizontal distance detected by the horizontal distance detector 460 and an emission angle of the light emitted by the light emitter 410. Then, a two-dimensional graph of the vertical distance calculated along the reference line is generated by the vertical-distance graph generating unit 450. The generated vertical distance graph is stored in the memory 490 and is used to correct the read image information.

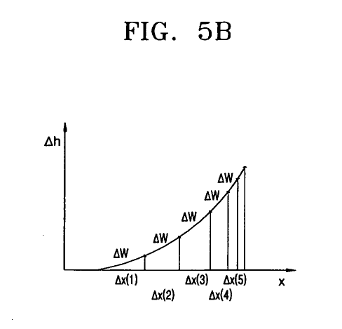

FIG. 5A is a diagram illustrating a vertical distance graph formed by the apparatus 400 to measure a vertical distance.

As described above, the vertical distance graph shown in FIG. 5B has linearity of the horizontal distance graph shown in FIG. 3 because the vertical distance Δh satisfies a relationship of the horizontal distance Δz to Equation 1. A horizontal axis shown in FIG. 5A shows a traveling direction along the reference line 215 and its vertical axis shows the vertical distance between the document and the flat bed.

FIG. 5B is a diagram explaining a process of calculating a distortion ratio at some portion of the vertical distance graph.

ΔW shown in FIG. 5B shows an actual length of the document to be scanned and Δx(n) shows a distance at which an actual length ΔW is projected to the flat bed. As shown in FIG. 5B, the more separated the actual length ΔW having the same distance is from the flat bed, the smaller a projected distance Δx(n). That is, the relationship is given by Equation 2.
Δx(5)<Δx(4)<Δx(3)<Δx(2)<Δx(1) Equation 2

Further, the relationship between an actual length ΔW and the projected distance Δx(n) is given by Equation 3.
Δx(n)=ΔW*cos(d(Δh)/dx) Equation 3

In Equation 3, d(Δh) shows a amount of change in a vertical distance and dx shows a amount of change of the actual length ΔW on the flat bed in a projected distance (scanned direction).

As can be seen in Expression 3, the actual length ΔW of the scanned document in the scan direction is distorted and is shown as Δx(n). Here, it is possible to recover an original length A W from the projected distance Δx(n) because the vertical distance Δh is calculated by the vertical distance detector.

That is, it is necessary to compensate for 5 pixels if a length of the scanned document in the scan direction is constituted of 100 pixels (ΔW) but becomes 95 pixels (Δx) due to the distortion. Various methods can be used for compensating for the distortion.

First, there is a method of compensating for images of the image information to be compensated by re-scanning the images with high resolution. The scanning is additionally performed by as much as a distortion ratio that is depending on a vertical distance of the scanned document. Here, the distortion ratio may be shown as a difference between the resolution of the read image information and the reference resolution. That is, the scanning should be additionally performed by as much as lost 5 pixels if the read image information indicates the resolution of 95 pixels when a document is scanned with resolution of 100 pixels. The distortion ratio may be a difference between the resolution of the read image information and the reference resolution or a ratio of the resolution of the read image information to the reference resolution. A method of compensating for the distortion through re-scanning takes much time because the scanning should be performed again to provide a good quality of the image information.

There is an interpolation as another compensation method. The interpolation is a method of estimating a function value f(x) of a variable x between known function values f(xi) when the function value f(x) of the variable x is not known but the function values f(xi) of two or more variable values xi (i=1, 2, . . . , n) having a certain interval are known. It is possible to approximate an unknown function by inserting the estimated function value between the known variables. The interpolation is in wide use for estimating a value at a point that is not measured on a basis of a measurement value obtained by an experiment or measurement. There are various interpolations such as proportional or linear interpolation and an interpolation formula of Newton. In this embodiment, all interpolations can be used to estimate unknown image information by using known image information. It is possible to decrease an operation time because a separate scanning operation is unnecessary when using interpolation. However, the interpolation causes an error when the length Δx is not enough small in the scan direction.

As another compensation method, there is a discrete-nonlinear compensation method. It is possible to compensate the vertical length when the vertical length of the scanned document shows a nonlinear curved line if the discrete-nonlinear compensation method is employed. That is, it is possible to extract a slope and height at a desired point if the nonlinear curved line is formulated by approximating it to be a polynomial.

There are various methods of approximating the nonlinear curved line to be a polynomial, and these methods can be used in the present general inventive concept. For example, the nonlinear curved line can be approximated by using Equation 4.
h=f(x)=a₀+a₁x+a₂x²+a₃x³ Equation 4

Therefore, a vertical distance Δh and slope can be obtained by dividing original data into discrete sections and using approximated polynomial. The correction may be performed by using the vertical distance Δh and slope.

Instead of approximating the nonlinear curved line to be a polynomial, the vertical distance at a measurement point may be stored in a lookup table, and the lookup table may be referred to in compensating for the distortion. In this case, as described above, the distortion can be compensated for by using a distortion ratio.

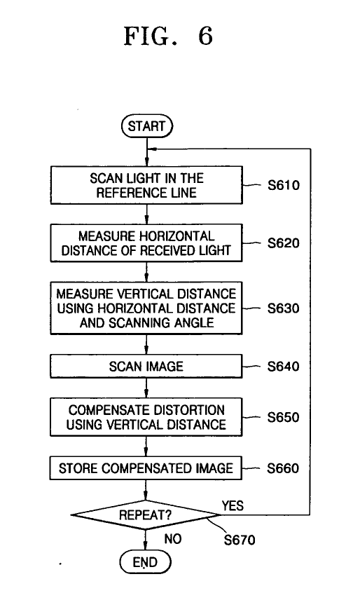

FIG. 6 is a flowchart illustrating a scanning method according to another embodiment of the present general inventive concept.

A document is scanned using light with respect to a reference line (S610). In this case, as described in FIGS. 2-6, the scanned light can become light having one of all wavelengths to be read by the light detector. Then, a horizontal distance from the reference line to a point of the scanned line where the light is detected is measured (S620). The horizontal distance of the measured light can be detected by a separate horizontal distance detector or by a light detector of a scanner.

A vertical distance is measured using the horizontal distance and a scanning angle when the horizontal distance of the detected light is measured. The vertical distance can be easily calculated from the horizontal distance using, for example, a trigonometry (S630). A plurality of vertical distances can form a vertical distance graph by calculating the vertical distances from horizontal distances along the reference line. The vertical distance graph is a graph showing the vertical distance at each of points on the scanned line of the document with respect to the reference line.

The image information about the scanned document is finally scanned when the vertical distance of the document is measured (S640). The distortion of the scanned image information is compensated for according to the vertical distance graph (S650). Various methods, such as re-scanning and interpolation, etc., can be used during the operation to compensate for the distortion. Therefore, the compensated image information is stored if the image information is compensated (S660). If necessary, the compensation operation can repeat to improve an image quality.

The above operation is repeated when there are more documents to be scanned (S670). It is possible to repeatedly perform the operation to measure a vertical distance if there are one or more documents to be scanned. The compensation operation can be repeated from an additional image scan operation (S640) using the measured vertical distance graph. However, it is possible to repeat again the compensation operation from the scanning and measuring operation to measure a vertical distance because vertical distances from other pages at the same book are not always equal.

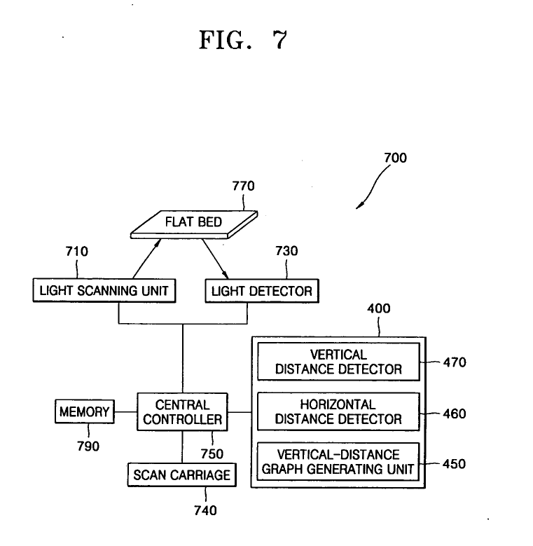

FIG. 7 is a block diagram illustrating a scanner 700 according to an embodiment of the present general inventive concept.

The scanner 700 includes a light scanning unit (or a light emitter) 410, a light detector 730, an apparatus 400 to measure a vertical distance, a central controller 750, a scan carriage 740, and a memory 790. The apparatus 400 to measure the vertical distance includes a vertical distance detector 470, a horizontal distance detector 460, and a vertical-distance graph generating unit 450. In FIG. 7, the horizontal distance detector 460 may be provided separately from the light detector 730, but this does not limit the present general inventive concept.

The light emitter 710 applies the light to a reference line on the flat bed 770 and a scanned line formed on the document by the scanned light is detected by the light detector 730 or the horizontal distance detector 460. The scan carriage 740 moves the light detector 730 along the reference line. The light detector 730 can be used to read image information of the document when a scanning device scans the document to read the image information from the documents, and the read image information can be compensated using the detected light emitted from the light emitter 710. The memory 790 stores the read image or the calculated vertical distance. The central controller 750 controls operations of the respective components of the scanner 700.

According to the present invention, there is provided with a vertical distance detection device capable of easily detecting a vertical distance between the flat bed and the document by using one light scanning lamp. It is possible to reduce a production cost and simply measure a vertical distance using a single light scanning lamp.

Further, according to the present general inventive concept, there is provided with a scanner having a function of detecting a vertical distance between the flat bed and the document and compensating for distorted image information by using the detected vertical distance.

Furthermore, according to the present general inventive concept, there is provided with a scanning method of compensating for the distorted image information using a vertical distance between the flat bed and the documents.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to measure a vertical distance between a document and a flat bed of a scanner comprising:
a light emitter to emit light at a predetermined emission angle along a predetermined reference line on a flat bed of a scanner;
a light detector to detect the scanned light;
a horizontal distance detector to measure a horizontal distance representing a separation between the detected light and the reference line; and
a vertical distance calculation unit to calculate a vertical distance representing a separation between the flat bed and the document placed on the flat bed according to the measured horizontal distance and the predetermined emission angle.

2. The apparatus according to claim 1, wherein the light emitter sequentially emits the light along the reference line, and the light detector detects the light in synchronization with the light emitter.

3. The apparatus according to claim 1, wherein the light emitter comprises a single light lamp to emit the light of a predetermined wavelength.

4. The apparatus according to claim 2, wherein the vertical distance calculation unit generates a vertical distance graph showing the vertical distance relative to a position along the reference line.

5. The apparatus according to claim 4, wherein the reference line is positioned at a center portion of the flat bed.

6. A scanner having a flat bed and to compensate for distortion of image information read from a document placed on the flat bed, the scanner comprising:
a calculation unit to measure a vertical distance between a document and a flat bed, the calculating unit comprising:
a light emitter to emit light at a predetermined emission angle along a predetermined reference line on the flat bed,
a light detector to detect the emitted light from the document,
a horizontal distance detector to detect a horizontal distance between the detected light and the reference line, and
a vertical distance calculation unit to calculate a vertical distance representing a separation between the flat bed and the document placed on the flat bed according to the measured horizontal distance and the predetermined emission angle;
a distortion compensation unit to adjust image information read from the document using the detected vertical distance; and
a central controller to control the calculation unit and the distortion compensation unit to compensate the read image information.

7. The scanner according to claim 6, wherein the light emitter sequentially emits the light along the reference line, and the light detector detects the light in synchronization with the light emitter.

8. The scanner according to claim 6, wherein the light emitter comprises a single light lamp to emit a predetermined wavelength of light.

9. The scanner according to claim 7, wherein the vertical distance calculation unit generates a vertical distance graph showing the vertical distance relative to a position along the reference line.

10. The scanner according to claim 9, wherein the reference line is positioned at a center portion of the flat bed.

11. The scanner according to claim 9, wherein the distortion compensation unit divides the vertical distance graph into predetermined sections, calculates a distortion ratio that is a difference between a resolution of the read image information and a reference resolution at each of the respective divided sections, and performs interpolation at each of the sections having the resolution of the read image information lower than the reference resolution based on the calculated distortion ratio.

12. The scanner according to claim 9, wherein the distortion compensation unit divides the vertical distance graph into predetermined sections, calculates a distortion ratio that is a difference between a resolution of the read image information and a reference resolution at each of the respective divided sections, and re-reads image information using a greater resolution at each of the sections having the resolution lower than the reference resolution based on the calculated distortion ratio.

13. The scanner according to claim 6, wherein the light detector comprises an image information reading unit to read the image information of the document placed on the flat bed.

14. A scanning method of compensating for distortion of image information read from a document placed on a flat bed comprising:
emitting light at a predetermined emission angle along a predetermined reference line on the flat bed;
detecting the emitted light from a document;
measuring a horizontal distance between the detected light and the predetermined reference line and calculating a vertical distance separating the document placed on the flat bed from the flat bed using the measured horizontal distance and the predetermined emission angle;
scanning the document to read the image information from the document; and
compensating for distortion of the read image information according to the detected vertical distance.

15. The scanning method according to claim 14, wherein the emitting of the light comprises sequentially emitting the light along the predetermined reference line, and the detecting of the emitted light comprises detecting the sequentially emitted light in synchronization with the sequential emitting of the light.

16. The scanning method according to claim 15, wherein the calculating of the vertical distance comprises generating a vertical distance graph showing the vertical distance relative to a position along the reference line.

17. The scanning method according to claim 16, wherein the reference line is positioned at a center portion of the flat bed.

18. The scanning method according to claim 16, wherein the compensating for the distortion of the read image information comprises:
dividing the vertical distance graph into predetermined sections;
calculating a distortion ratio that is a difference between a resolution of the read image information and a reference resolution at each of the respective divided sections; and
adjusting the image information of each of the sections having the resolution lower than the reference resolution based on the distortion ratio.

19. The scanning method according to claim 18, wherein the adjusting of the image information comprises performing interpolation at each of the sections having the resolution lower than the reference resolution.

20. The scanning method according to claim 18, wherein the adjusting of the image information comprises re-reading the image information with another resolution at each of the sections having the resolution lower than the reference resolution.

21. An apparatus usable with a scanner to measure a distance between a document and a scanning bed on which the document is scanned, the apparatus comprising:
a light emitter to emit light at a predetermined angle with respect to a scanning bed to form a scanned line on a document through the scanning bed on which the document is placed to be scanned;
a light detector to detect the scanned line formed on the document by the light of the light emitter; and
a controller to measure distance information representing a separation between the scanned line of the document and a reference line of the scanning bed.

22. The apparatus according to claim 21, further comprising:
a unit to emit second light and to read image information from the document using the second light,
wherein the controller compensates for distortion of the image information according to the distance information.

23. The apparatus according to claim 21, wherein the light emitter is disposed at a position which is not on a plane perpendicular to the scanning bed and the reference line so that the light is incident to the scanning bed at the predetermined angle.

24. The apparatus according to claim 21, wherein the light detector is movable with respect to the scanning bed, and the light emitter is stationary.

25. The apparatus according to claim 21, wherein the light detector has a length in a direction perpendicular to the reference line and movable in a direction parallel to the reference line, and the light emitter is stationary.

26. An apparatus usable with a scanner to compensate image information of a document which is disposed on a scanning bed, the apparatus comprising:
a scanning bed having a reference line and to face a document disposed thereon;
a light emitter to emit light to be incident on the document to form a scanned line thereon;
a light detector to detect the scanned line formed on the document;
a second light emitter unit to emit second light to be incident on the document;
a second light detector to detect image information using the second light; and
a controller to measure a separation between the document and the scanning bed according to the scanned line and the reference line, and to compensate the image information of the document according to the separation.

27. An apparatus usable with a scanner to compensate image information of a document which is disposed on a scanning bed, the apparatus comprising:
a scanning bed;
a light emitter to emit light at a predetermined angle with respect to a scanning bed to form a scanned line on a document which is disposed to face the scanning bed;
a light detector to detect the scanned line formed on the document by the light of the light emitter; and
a controller to measure distance information representing a separation between the document and the scanning bed by comparing the scanned line and a reference line so that image information of the document is compensated according to the distance information.
